(19) United States
(12) Patent Application Publication
(10) Pub. No.: US 2016/0368063 A1
(43) Pub. Date: Dec. 22, 2016

(54) BORING TOOL AND BORING METHOD USING SAME

(71) Applicant: TOYOTA JIDOSHA KABUSHIKI KAISHA, Toyota-shi (JP)

(72) Inventor: Takashi TERANISHI, Nagakute-shi (JP)

(73) Assignee: TOYOTA JIDOSHA KABUSHIKI KAISHA, Toyota-shi (JP)

(21) Appl. No.: 14/902,269

(22) PCT Filed: Apr. 28, 2014
(86) PCT No.: PCT/JP14/61836

§ 371 Date: Dec. 30, 2015

(30) Foreign Application Priority Data
Jul. 5, 2013 (JP) 2013-141973

(51) Int. Cl. B23B 29/02; B23B 41/12

(52) U.S. Cl. CPC B23B 29/02; B23B 41/12; B23B 2229/04; B23B 2229/08; B23B 2229/12

(57) ABSTRACT

A boring tool for performing boring on a workpiece having through holes placed coaxially includes a shaft member, first and second cutting blades, and first and second guides. The shaft member is rotationally driven by a machine tool. The first blade cuts an inner peripheral surface of a first through hole. The first guide slides on the inner peripheral surface of the first hole. The second blade cuts the inner peripheral surface of the first hole. The second guide slides on the inner peripheral surface of the first hole. The first guide slides on an inner peripheral surface of one of the through holes cut by the first blade, when the first hole is cut by the second blade. The second guide slides on an inner peripheral surface of one of the through holes cut by the second blade, when the first hole is cut by the second blade.

### TECHNICAL FIELD

The present invention relates to a boring tool for machining a plurality of through holes formed in a workpiece, and a boring method using the same.

### BACKGROUND ART

Conventionally, there has been widely known a boring tool that cuts an inner peripheral surface of a hole formed in a workpiece so as to adjust an inside diameter of the hole (see, for example, Patent Document 1).

Generally, the conventional boring tool includes: a generally pillar-shaped shaft member having one end attached to a machine tool so as to be rotationally driven around a shaft center; a cutting blade that is fixed to the shaft member and cuts the inner peripheral surface of the hole of the workpiece; and a guide that is fixed to the shaft member and slides on that inner peripheral surface of the hole of the workpiece which has been cut by the cutting blade.

In such a boring tool, the guide slides on that inner peripheral surface of the hole of the workpiece which has been cut by the cutting blade, so as to restrain vibration of the shaft member, thereby making it possible to cut the inner peripheral surface of the hole of the workpiece with accuracy.

However, in a case where boring is performed, with the use of the boring tool, on a workpiece (e.g., a cylinder head and a cylinder block) in which a plurality of through holes is formed coaxially, it is difficult to cut inner peripheral surfaces of the through holes of the workpiece with accuracy.

With reference to FIG. 12, the following more specifically describes a problem to occur when boring is performed on a workpiece W with the use of a conventional boring tool 100.

As illustrated in FIG. 12, the boring tool 100 includes a shaft member 101, a cutting blade 102, and a guide 103.

The shaft member 101 is formed in a generally pillar shape, and a mounting portion 101a to be attached to a machine tool is formed in one end (a left end in FIG. 12) thereof.

The cutting blade 102 is fixed to the other end (a right end in FIG. 12) of the shaft member 101 so as to project outward in a radial direction from an outer peripheral surface of the shaft member 101.

The guide 103 is provided continuously from the other end of the shaft member 101 to a vicinity of the mounting portion 101a in an axial direction so as to project outward in the radial direction from the outer peripheral surface of the shaft member 101. The guide 103 is placed so as to be opposed to the cutting blade 102 in a circumferential direction of the shaft member 101.

The workpiece W includes four support portions Ws1, Ws2, Ws3, Ws4 for supporting a rotation shaft such as a camshaft and a crankshaft.

Four through holes Wh1, Wh2, Wh3, Wh4 are folioed coaxially in the support portions Ws1, Ws2, Ws3, Ws4, respectively.

The boring tool 100 cuts an inner peripheral surface of each through hole by the cutting blade 102 in order of the through bole Wh1, the through bole Wh2, the through hole Wh3, and the through hole Wh4.

The shaft member 101 of the boring tool 100 should have an axial dimension larger than a shaft member of a boring tool for perform boring on a workpiece having only one through hole, so that the cutting blade 102 and the guide 103 reach the through hole Wh4 placed at an innermost position in the workpiece W. Since the shaft member 101 is in a cantilever state in which only one end (the mounting portion 101a) thereof is supported by the machine tool, when a distance in the shaft member 101 from the mounting portion 101a to a part where the cutting blade 102 is fixed is increased, the part where the cutting blade 102 is fixed vibrates in a direction perpendicular to the axial direction (see black arrows in FIG. 12), so that an inside diameter of each through hole to be cut by the cutting blade 102 might become larger than a target value.

### CITATION LIST

### Patent Documents

Patent Document 1: Japanese Patent Application Publication No. 2006-305641 (JP 2006-305641 A)

### SUMMARY OF THE INVENTION

### Problem to be Solved by the Invention

An object of the present invention is to provide a technique that can cut inner peripheral surfaces of a plurality of through holes formed in a workpiece with accuracy.

### Means for Solving the Problem

A boring tool according to the present invention is a boring tool for performing boring on a workpiece, as a machining object, which has a plurality of through holes formed coaxially and distanced from each other, in such a manner that the boring tool is inserted into the plurality of through holes sequentially, and includes: a shaft member having one end attached to a machine tool and rotationally driven by the machine tool around a shaft center; a first cutting blade fixed to the shaft member so as to project from an outer peripheral surface of the shaft member and configured to cut an inner peripheral surface of a through hole of the workpiece so that the through hole has a predetermined inside diameter; a first guide fixed to the shaft member so as to project from the outer peripheral surface of the shaft member and configured to slide on the inner peripheral surface of the through hole that has been cut by the first cutting blade; a second cutting blade fixed to the shaft member so as to project from the outer peripheral surface of the shaft member and configured to cut the inner peripheral surface of the through hole that has been cut by the first cutting blade so that the through hole has a predetermined inside diameter; and a second guide fixed to the shaft member so as to project from the outer peripheral surface of the shaft member and configured to slide on the inner peripheral surface of the through hole that has been cut by the second cutting blade, and the second cutting blade is placed on one end side of the shaft member relative to the first cutting blade at a predetermined interval from the first cutting blade, the first guide is placed such that the first guide slides on an inner peripheral surface of at least one through hole that has been cut by the first cutting blade, at the time when the inner peripheral surface of the through hole is cut by the second cutting blade, and the second guide is placed on one end side of the shaft member relative to the first guide such that the second guide slides on an inner peripheral surface of at least one through hole that has been cut by the second cutting blade, at the time when the inner peripheral surface of the through hole is cut by the second cutting blade.

In the boring tool according to the present invention, it is preferable that the shaft member include a small diameter portion having a predetermined outside diameter and formed over a halfway portion in an axial direction from the other end of the shaft member, and a large diameter portion having an outside diameter larger than the small diameter portion and formed coaxially and integrally with the small diameter portion on one end side of the shaft member relative to the small diameter portion; the first cutting blade and the first guide be fixed to the small diameter portion; and the second cutting blade and the second guide be fixed to the large diameter portion.

In the boring tool according to the present invention, it is preferable that the first cutting blade be placed such that the first cutting blade is able to cut an inner peripheral surface of a through hole adjacent to the through hole that is cut by the second cutting blade, at the time when the inner peripheral surface of the through hole is cut by the second cutting blade.

A boring method according to the present invention is a boring method of performing boring on a plurality of through holes of the workpiece by use of the boring tool described above, and includes: a step of preparing a reference hole forming tool including a short shaft member rotationally driven around a shaft center by the machine tool to be attached to one end thereof and having an axial dimension smaller than the shaft member, a cutting blade fixed to the short shaft member so as to project from an outer peripheral surface of the short shaft member and configured to cut an inner peripheral surface of a through hole of the workpiece so that the through hole has an inside diameter not smaller than a machining diameter of the first cutting blade but smaller than a machining diameter of the second cutting blade, and a guide configured to slide on the inner peripheral surface of the through hole that has been cut by the cutting blade; a step of cutting, by the cutting blade of the reference hole forming tool, an inner peripheral surface of a through hole placed on one end among the plurality of through holes in the workpiece, so that the through hole serves as a reference hole; a step of inserting the shaft member of the boring tool into the reference hole and cutting an inner peripheral surface of the reference hole by the second cutting blade; and a step of cutting an inner peripheral surface of a through hole adjacent to the reference hole by the first cutting blade.

### Advantageous Effects of Invention

According to the present invention, it is possible to cut inner peripheral surfaces of a plurality of through holes formed in a workpiece with accuracy.

### BRIEF DESCRIPTION OF THE DRAWINGS

FIG. 1(a) is a view illustrating a side view of a boring tool according to the present invention, and FIG. 1(b) is a cut end view thereof.

FIG. 2 is a view illustrating outside diameters of rotation loci of a first cutting blade and a second cutting blade, and a first guide and a second guide.

FIG. 3 is a view illustrating a boring step using the boring tool according to the present invention.

FIG. 4 is a view illustrating a reference hole forming step.

FIG. 5 is a view illustrating a first cutting step.

FIG. 6 is a view illustrating a state in which adjacent through holes in a workpiece are cut at the same time by the first cutting blade and the second cutting blade.

FIG. 7 is a view illustrating a second cutting step.

FIG. 8 is a view illustrating a third cutting step.

FIG. 9 is a view illustrating a fourth cutting step.

FIG. 10 is a view illustrating a case where an interval between adjacent support portions in the workpiece is small.

FIG. 11 is a view illustrating a case where an interval between adjacent support portions in the workpiece is large.

FIG. 12 is a view illustrating a state where boring is performed on a workpiece with the use of a conventional boring tool.

### MODES FOR CARRYING OUT THE INVENTION

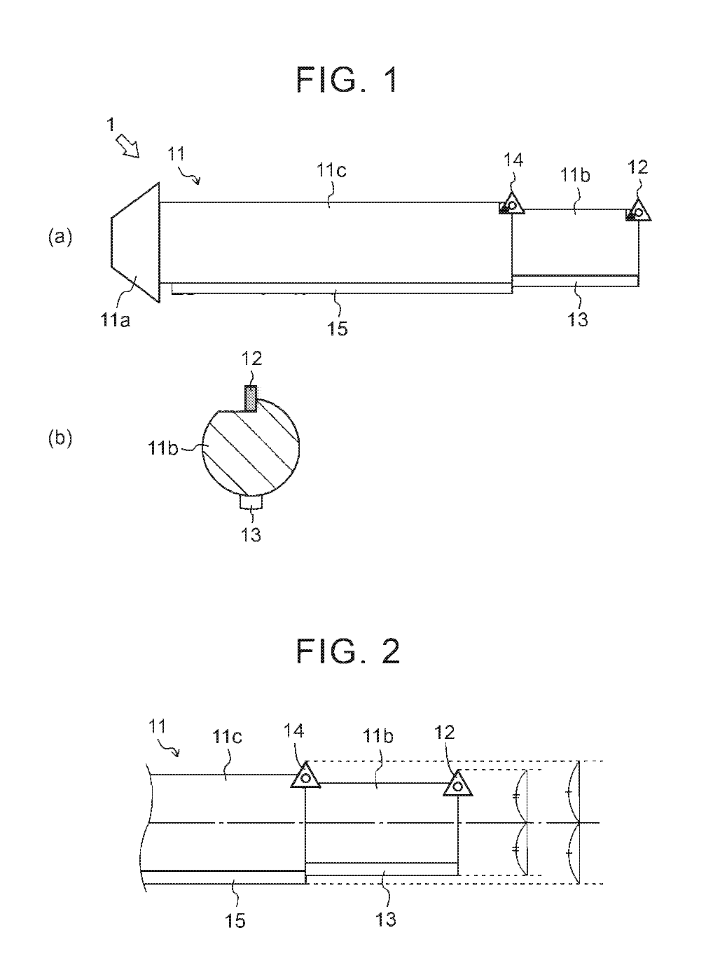

With reference to FIGS. 1 and 2, the following describes a boring tool 1, which is one embodiment of a boring tool according to the present invention.

The boring tool 1 is a tool for performing boring on a workpiece W.

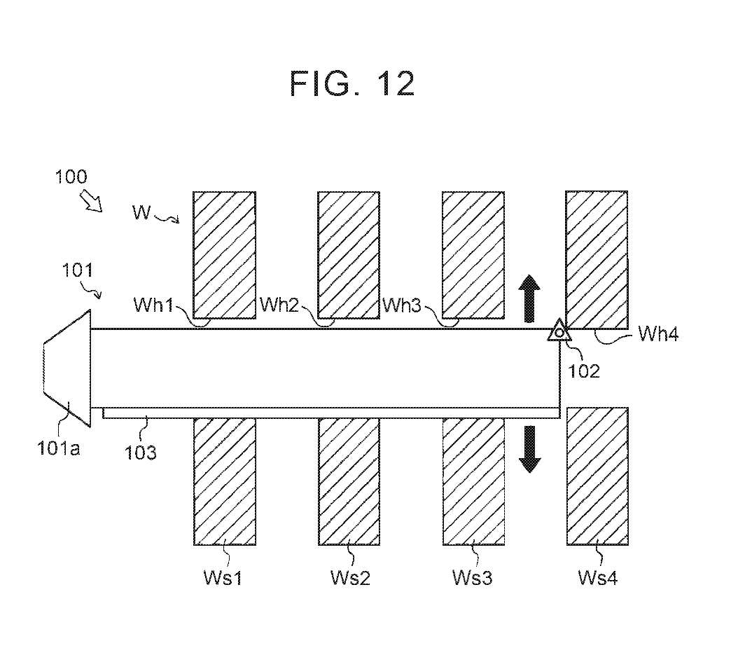

The workpiece W is a member such as a cylinder head and a cylinder block in which a plurality of through holes is formed coaxially. In the present embodiment, the workpiece W is a cylinder head that forms part of an internal combustion engine. The workpiece W includes four support portions Ws1, Ws2, Ws3, Ws4 for supporting a camshaft, and four through holes Wh1, Wh2, Wh3, Wh4 are formed coaxially in the support portions Ws1, Ws2, Ws3, Ws4, respectively (see FIG. 12).

The support portions Ws1, Ws2, Ws3, Ws4 are formed in a wall shape having the same thickness (a right-left dimension in FIG. 12), and are placed at the same interval.

The through holes Wh1, Wh2, Wh3, Wh4 are formed so as to penetrate through the support portions Ws1, Ws2, Ws3, Ws4, respectively, in a thickness direction. The through holes Wh1, Wh2, Wh3, Wh4 are formed in a circular shape when viewed from the thickness direction of the support portions Ws1, Ws2, Ws3, Ws4, and are placed coaxially. The through holes Wh1, Wh2, Wh3, Wh4 are set to have the same inside diameter.

Note that, in the following description, a right-left direction in FIG. 1(a) is defined as a right-left direction of the boring tool 1 for purposes of this description.

As illustrated in FIG. 1(a), the boring tool 1 includes a shaft member 11, a first cutting blade 12, a first guide 13, a second cutting blade 14, and a second guide 15.

The shaft member 11 is formed in a generally pillar shape and extends in the right-left direction.

The shaft member 11 includes a mounting portion 11a, a small diameter portion 11b, and a large diameter portion 11c.

The mounting portion 11a is formed in a left end of the shaft member 11, and is attached to a machine tool such as a machining center. That is, the shaft member 11 is attached to the machine tool via the mounting portion 11a and is rotationally driven by the machine tool around a shaft center.

The small diameter portion 11b is smaller than an outside diameter of the large diameter portion 11c, and has an outside diameter that is generally the same as inside diameters of the through holes Wh1, Wh2, Wh3, Wh4 of the workpiece W. The small diameter portion 11b is placed on a right end side of the shaft member 11. More specifically, the small diameter portion 11b is formed over a halfway portion in an axial direction from a right end of the shaft member 11.

The large diameter portion 11c has an outside diameter larger than the outside diameter of the small diameter portion 11b. The large diameter portion 11c is placed on a left end side of the shaft member 11. More specifically, the large diameter portion 11c is formed concentrically and integrally with the mounting portion 11a and the small diameter portion 11b from the mounting portion 11a to the small diameter portion 11b.

The first cutting blade 12 is a member configured to be able to cut an inner peripheral surface of each through hole in the workpiece W. The first cutting blade 12 is fixed to a right end of the small diameter portion 11b so as to project outward in a radial direction from an outer peripheral surface of the small diameter portion 11b. The first cutting blade 12 rotates along with a rotation of the shaft member 11, and cuts an inner peripheral surface of each through hole of the workpiece W so that the each through hole has a predetermined inside diameter. A machining diameter of the first cutting blade 12 is set to become smaller than a machining diameter of the second cutting blade 14.

Here, the machining diameter is an outside diameter of a rotation locus of a member that cuts the inner peripheral surface of each through hole in the workpiece W, such as the first cutting blade 12 and the second cutting blade 14. That is, the machining diameter of the first cutting blade 12 is the same as an inside diameter of the through hole the inner peripheral surface of which has been cut by the first cutting blade 12.

The first guide 13 is a member configured to be slidable on the inner peripheral surface of the through hole that has been cut by the first cutting blade 12. The first guide 13 is provided continuously over both ends of the small diameter portion 11b in the axial direction so as to project outward in the radial direction from the outer peripheral surface of the small diameter portion 11b, and fixed to the outer peripheral surface of the small diameter portion 11b by brazing.

As illustrated in FIG. 1(b), the first guide 13 is placed so as to be opposed to the first cutting blade 12 in the circumferential direction of the small diameter portion 11b. That is, the first guide 13 and the first cutting blade 12 are placed with a phase difference of 180 degrees.

As illustrated in FIG. 2, a distance from a sliding surface (a bottom end surface in FIG. 2) of the first guide 13 to a shaft center of the shaft member 11 is set to be equal to a distance from a tip (an upper end in FIG. 2) of the first cutting blade 12 to the shaft center of the shaft member 11. That is, an outside diameter of a rotation locus of the first guide 13 is the same as the machining diameter of the first cutting blade 12. Note that, in the following description, an outside diameter of a rotation locus of a member that slides on the inner peripheral surface of each through hole in the workpiece W, such as the first guide 13 and the second guide 15, is referred to as a guide diameter.

The first guide 13 slides on the inner peripheral surface of the through hole that has been cut by the first cutting blade 12 along with a rotation of the shaft member 11, so as to restrain the shaft member 11 from vibrating in a direction perpendicular to the axial direction at the time when the first cutting blade 12 cuts the inner peripheral surface of the through hole.

The second cutting blade 14 is a member configured to be able to cut the inner peripheral surface of the through hole that has been cut by the first cutting blade 12.

As illustrated in FIG. 1(a), the second cutting blade 14 is fixed to a right end of the large diameter portion 11c so as to project outward in the radial direction from an outer peripheral surface of the large diameter portion 11c. The second cutting blade 14 is placed at the same position as the first cutting blade 12 in the circumferential direction of the shaft member 11. The machining diameter of the second cutting blade 14 is set to become larger than the machining diameter of the first cutting blade 12. The second cutting blade 14 rotates along with a rotation of the shaft member 11, and cuts the inner peripheral surface of the through hole that has been cut by the first cutting blade 12, so that the through hole has a predetermined inside diameter.

The second guide 15 is a member configured to be slidable on the inner peripheral surface of the through hole that has been cut by the second cutting blade 14. The second guide 15 is provided continuously from a right end of the large diameter portion 11c to a vicinity of the mounting portion 11a so as to project outward in the radial direction from the outer peripheral surface of the large diameter portion 11c, and fixed to the outer peripheral surface of the large diameter portion 11c by brazing. The second guide 15 is placed at the same position as the first guide 13 in the circumferential direction of the shaft member 11. That is, the second guide 15 is placed so as to be opposed to the second cutting blade 14 in the circumferential direction of the large diameter portion 11c.

As illustrated in FIG. 2, a distance from a sliding surface (a bottom end surface in FIG. 2) of the second guide 15 to the shaft center of the shaft member 11 is set to be equal to a distance from a tip (an upper end in FIG. 2) of the second cutting blade 14 to the shaft center of the shaft member 11. That is, a guide diameter of the second guide 15 is the same as the machining diameter of the second cutting blade 14.

The second guide 15 slides on the inner peripheral surface of the through hole that has been cut by the second cutting blade 14 along with a rotation of the shaft member 11, so as to restrain the shaft member 11 from vibrating in the direction perpendicular to the axial direction at the time when the second cutting blade 14 cuts the inner peripheral surface of the through hole.

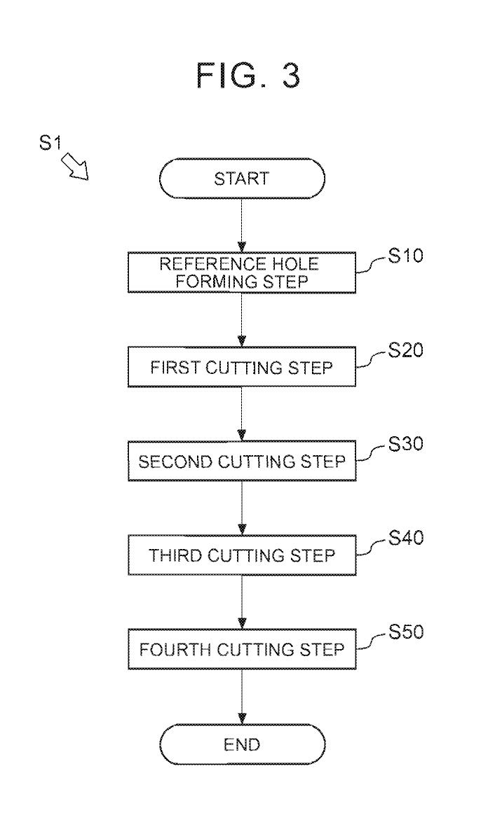

With reference to FIGS. 3 to 11, the following describes a boring step S1 using the boring tool 1, which is one embodiment of a boring method according to the present invention.

The boring step S1 is a step of adjusting the inside diameters of the through holes Wh1, Wh2, Wh3, Wh4 of the workpiece W by use of the boring tool 1.

As illustrated in FIG. 3, the boring step S1 includes a reference hole forming step S10, a first cutting step S20, a second cutting step S30, a third cutting step S40, and a fourth cutting step S50.

The reference hole forming step S10 is a step of cutting the inner peripheral surface of the through hole Wh1 by use of a reference hole forming tool 2.

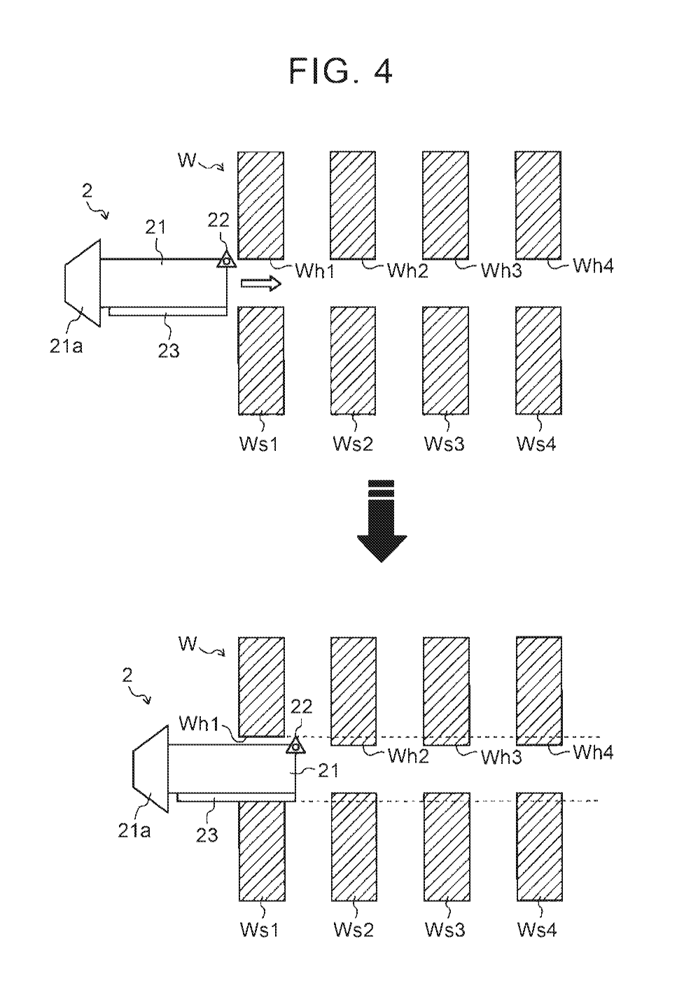

As illustrated in FIG. 4, the reference hole forming tool 2 includes a short shaft member 21, a cutting blade 22, and a guide 23.

Note that, in the following description, a right-left direction in FIG. 4 is defined as a right-left direction of the reference hole forming tool 2 for purposes of this description.

The short shaft member 21 is formed in a generally pillar shape, and a mounting portion 21a to be attached to the machine tool is formed in a left end thereof. An axial dimension of the short shaft member 21 is set to be smaller than that of the shaft member 11 of the boring tool 1. An outside diameter of the short shaft member 21 except for the mounting portion 21a is set to the same dimension as the inside diameter of the through hole Wh1.

The short shaft member 21 is attached to the machine tool via the mounting portion 21a and is rotationally driven by the machine tool around a shaft center.

The cutting blade 22 is a member configured to be able to cut the inner peripheral surface of the through hole Wh1 of the workpiece W. The cutting blade 22 is fixed to a right end of the short shaft member 21 so as to project outward in the radial direction from an outer peripheral surface of the short shaft member 21. The cutting blade 22 rotates along with a rotation of the short shaft member 21, and cuts the inner peripheral surface of the through hole Wh1 so that the through hole Wh1 has a predetermined inside diameter. A machining diameter of the cutting blade 22 is set to be not smaller than the machining diameter of the first cutting blade 12 but to be smaller than the machining diameter of the second cutting blade 14. In the present embodiment, the machining diameter of the cutting blade 22 is set to be generally the same as the machining diameter of the first cutting blade 12.

The guide 23 is a member configured to be slidable on the inner peripheral surface of the through hole Wh1 that has been cut by the cutting blade 22. The guide 23 is provided continuously from a right end of the short shaft member 21 to a vicinity of the mounting portion 21a so as to project outward in the radial direction from the outer peripheral surface of the short shaft member 21, and fixed to the outer peripheral surface of the short shaft member 21 by brazing. The guide 23 is placed so as to be opposed to the cutting blade 22 in a circumferential direction of the short shaft member 21. A guide diameter of the guide 23 is the same as the machining diameter of the cutting blade 22.

The guide 23 slides on the inner peripheral surface of the through hole Wh1 that has been cut by the cutting blade 22 along with a rotation of the short shaft member 21, so as to restrain the short shaft member 21 from vibrating in a direction perpendicular to the axial direction at the time when the cutting blade 22 cuts the inner peripheral surface of the through hole Wh1.

In the reference hole forming step S10, the reference hole forming tool 2 driven by the machine tool is inserted into the through hole Wh1 of the workpiece W from its right end, and moved in a right direction until the cutting blade 22 passes the through hole Wh1.

Thus, the inside diameter of the through hole Wh1 is adjusted to the same as the machining diameter of the cutting blade 22.

Note that, at the time when the reference hole forming tool 2 is inserted into the through hole Wh1, a position of the reference hole forming tool 2 is adjusted so that a center of the through hole Wh1 after the cutting is placed at an appropriate position. On that account, even in a case where the through hole Wh1 deviates from the appropriate position, by cutting the inner peripheral surface of the through hole Wh1 by the reference hole forming tool 2, the position of the through hole Wh1 is adjusted. Note that the axial dimension of the short shaft member 21 is relatively small, so even in a cantilever state in which only a left end of the short shaft member 21 is supported by the machine tool, the short shaft member 21 is restrained from vibrating in the direction perpendicular to the axial direction.

Thus, the center of the through hole Wh1 that has been cut by the reference hole forming tool 2 is placed at the appropriate position, so that the boring tool 1 is placed at an appropriate position at the time when the boring tool 1 is inserted into the through hole Wh1 in a subsequent step (the first cutting step S20). That is, the through hole Wh1 that has been cut by the reference hole forming tool 2 functions as a reference hole for the boring tool 1 to perform boring on the workpiece W at an appropriate position.

After the through hole Wh1 is cut, the reference hole forming tool 2 is moved in a left direction and pulled out from the through hole Wh1.

The first cutting step S20 is a step of adjusting the through hole Wh1 that has been cut by the reference hole forming tool 2 to a final inside diameter by use of the boring tool 1.

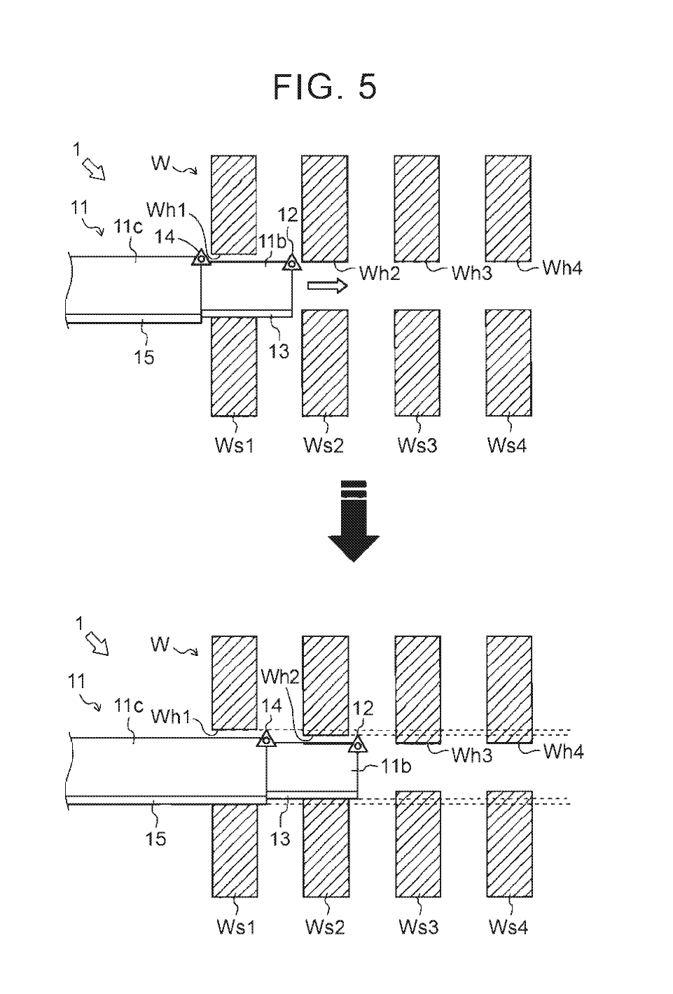

As illustrated in FIG. 5, in the first cutting step S20, first, in a state where the machine tool is stopped, the boring tool 1 is inserted into the through hole Wh1 of the workpiece W from its right end and moved in the right direction until the first cutting blade 12 passes the through hole Wh1.

Then, the boring tool 1 thus driven by the machining tool is moved in the right direction until the second cutting blade 14 passes the through hole Wh1.

Thus, the inside diameter of the through hole Wh1 is adjusted to the same as the machining diameter of the second cutting blade 14.

Note that, in the present embodiment, an axial dimension of the small diameter portion 11b of the shaft member 11 is set to be generally the same as a distance between one end surfaces (e.g., left end surfaces of the support portions Ws1 and Ws2), in the right-left direction, of adjacent support portions in the workpiece W.

On that account, the first cutting blade 12 cuts the inner peripheral surface of the through hole Wh2 at the same time as the second cutting blade 14 cuts the inner peripheral surface of the through hole Wh1. Further, the first cutting blade 12 passes the through hole Wh2 at the same time as the second cutting blade 14 passes the through hole Wh1, so that the inside diameter of the through hole Wh2 is adjusted to the same as the machining diameter of the first cutting blade 12.

In the first cutting step S20, when the boring tool 1 is inserted into the through hole Wh1, the inner peripheral surface of the through hole Wh1 might be damaged by the first cutting blade 12.

However, in the reference hole forming step S10, the machining diameter of the cutting blade 22 in the reference hole forming tool 2 is set to be generally the same as the machining diameter of the first cutting blade 12, and the through hole Wh1 is cut by the cutting blade 22 of the reference bole forming tool 2 so that the through hole Wh1 becomes smaller than a final inside diameter (the machining diameter of the second cutting blade 14). That is, the through hole Wh1 is cur by the cutting blade 22 of the reference hole forming tool 2 so that a machining allowance remains.

Accordingly, the inner peripheral surface of the through hole Wh1 that has been cut by the cutting blade 22 of the reference hole forming tool 2 is cut by the second cutting blade 14, thereby making it possible to prevent scratches from finally remaining on the inner peripheral surface of the through hole Wh1.

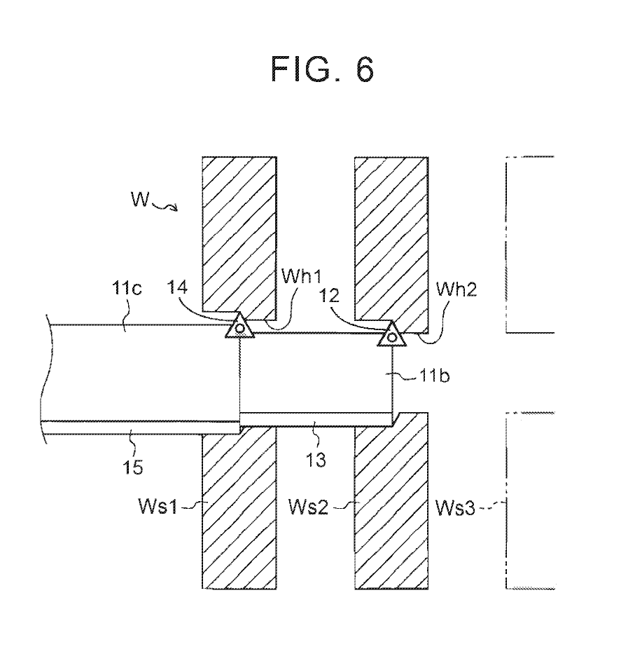

As illustrated in FIG. 6, in the first cutting step S20, the first cutting blade 12 cuts the inner peripheral surface of the through hole Wh2 at the time when the second cutting blade 14 cuts the inner peripheral surface of the through hole Wh1.

At this time, the small diameter portion 11b and the large diameter portion 11c are inserted into the through hole Wh2 and the through hole Wh1, respectively.

Accordingly, the first guide 13 slides on the inner peripheral surface of the through hole Wh2 that has been cut by the first cutting blade 12 and the inner peripheral surface of the through hole Wh1 that has been cut by the first cutting blade 12, and the second guide 15 slides on the inner peripheral surface of the through hole Wh1 that has been cut by the second cutting blade 14.

As such, the shaft member 11 is supported by the first guide 13 and the second guide 15 on a right side and a left side of the second cutting blade 14. Further, the mounting portion 11a (see FIG. 1(a)) placed in a left end of the shaft member 11 is supported by the machine tool. That is, the shaft member 11 is supported at both ends.

This makes it possible to restrain the shaft member 11 from vibrating in the direction perpendicular to the axial direction in a part (a right end of the large diameter portion 11c) where the second cutting blade 14 is attached.

Accordingly, it is possible to cut the inner peripheral surface of the through hole Wh1 with accuracy without the inside diameter of the through hole Wh1 becoming larger than a target value.

The second cutting step S30 is a step of adjusting the through hole Wh2 to a final inside diameter by use of the boring tool 1.

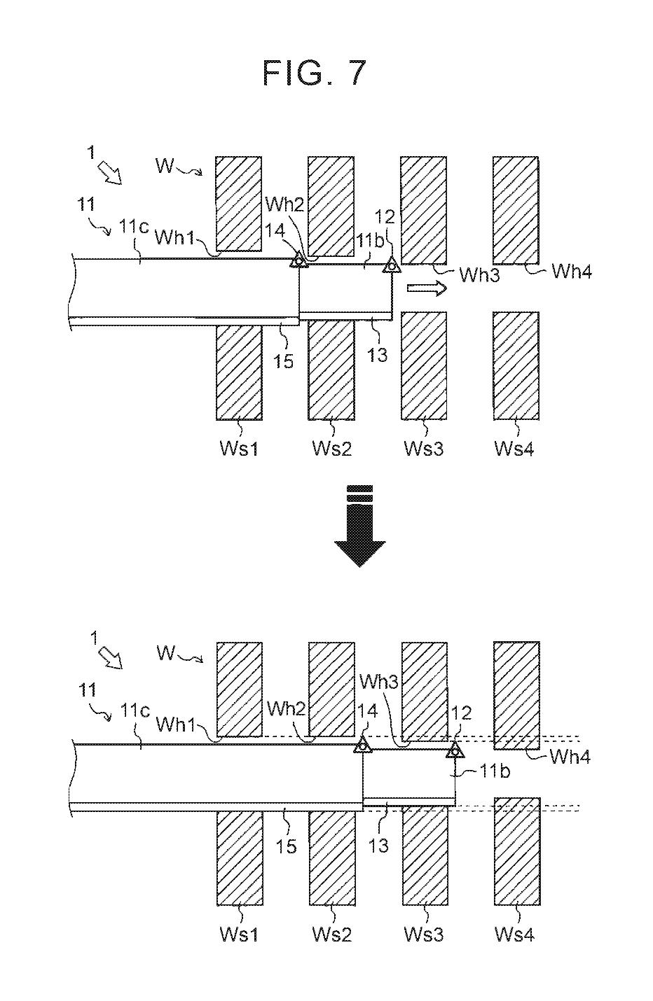

As illustrated in FIG. 7, in the second cutting step S30, the boring tool 1 driven by the machining tool is moved in the right direction until the second cutting blade 14 passes the through hole Wh2 and the first cutting blade 12 passes the through hole Wh3.

Thus, the inside diameter of the through hole Wh2 is adjusted to the same as the machining diameter of the second cutting blade 14, and the inside diameter of the through hole Wh3 is adjusted to the same as the machining diameter of the first cutting blade 12.

In the second cutting step S30, at the time when the second cutting blade 14 and the first cutting blade 12 cut the through hole Wh2 and the through hole Wh3, the first guide 13 slides on the inner peripheral surface of the through hole Wh3 that has been cut by the first cutting blade 12 and the inner peripheral surface of the through hole Wh2 that has been cut by the first cutting blade 12, and the second guide 15 slides on the inner peripheral surface of the through hole Wh2 that has been cut by the second cutting blade 14 and the inner peripheral surface of the through hole Wh1 that has been cut by the second cutting blade 14.

As such, the shaft member 11 is supported by the first guide 13 and the second guide 15 on the right side and the left side of the second cutting blade 14. Further, the mounting portion 11a (see FIG. 1(a)) placed in the left end of the shaft member 11 is supported by the machine tool. That is, the shaft member 11 is supported at both ends.

This makes it possible to restrain the shaft member 11 from vibrating in the direction perpendicular to the axial direction in a part (the right end of the large diameter portion 11c) where the second cutting blade 14 is attached.

Accordingly, it is possible to cut the inner peripheral surface of the through hole Wh2 with accuracy without the inside diameter of the through hole Wh2 becoming larger than a target value.

The third cutting step S40 is a step of adjusting the through hole Wh3 to a final inside diameter by use of the boring tool 1.

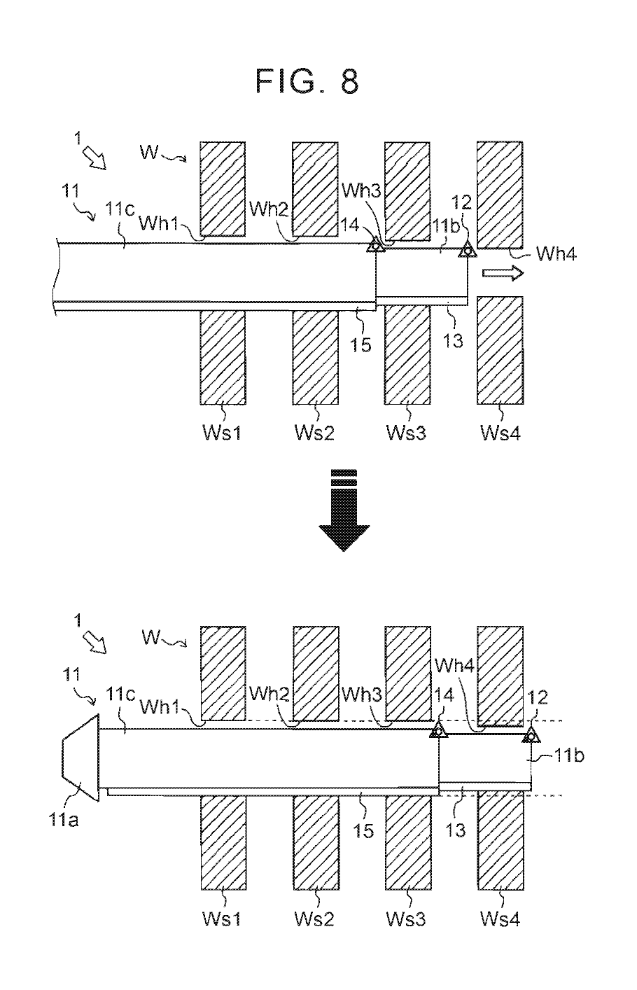

As illustrated in FIG. 8, in the third cutting step S40, the boring tool 1 driven by the machining tool is moved in the right direction until the second cutting blade 14 passes the through hole Wh3 and the first cutting blade 12 passes the through hole Wh4.

Thus, the inside diameter of the through hole Wh3 is adjusted to the same as the machining diameter of the second cutting blade 14, and the inside diameter of the through hole Wh4 is adjusted to the same as the machining diameter of the first cutting blade 12.

In the third cutting step S40, at the time when the second cutting blade 14 and the first cutting blade 12 cut the through hole Wh3 and the through hole Wh4, the first guide 13 slides on the inner peripheral surface of the through hole Wh4 that has been cut by the first cutting blade 12 and the inner peripheral surface of the through hole Wh3 that has been cut by the first cutting blade 12, and the second guide 15 slides on the inner peripheral surface of the through hole Wh3 that has been cut by the second cutting blade 14, the inner peripheral surface of the through hole Wh2 that has been cut by the second cutting blade 14, and the inner peripheral surface of the through hole Wh1 that has been cut by the second cutting blade 14.

As such, the shaft member 11 is supported by the first guide 13 and the second guide 15 on the right side and the left side of the second cutting blade 14. Further, the mounting portion 11a (see FIG. 1(a)) placed in the left end of the shaft member 11 is supported by the machine tool. That is, the shaft member 11 is supported at both ends.

This makes it possible to restrain the shaft member 11 from vibrating in the direction perpendicular to the axial direction in a part (the right end of the large diameter portion 11c) where the second cutting blade 14 is attached.

Accordingly, it is possible to cut the inner peripheral surface of the through hole Wh3 with accuracy without the inside diameter of the through hole Wh3 becoming larger than a target value.

The fourth cutting step S50 is a step of adjusting the through hole Wh4 to a final inside diameter by use of the boring tool 1.

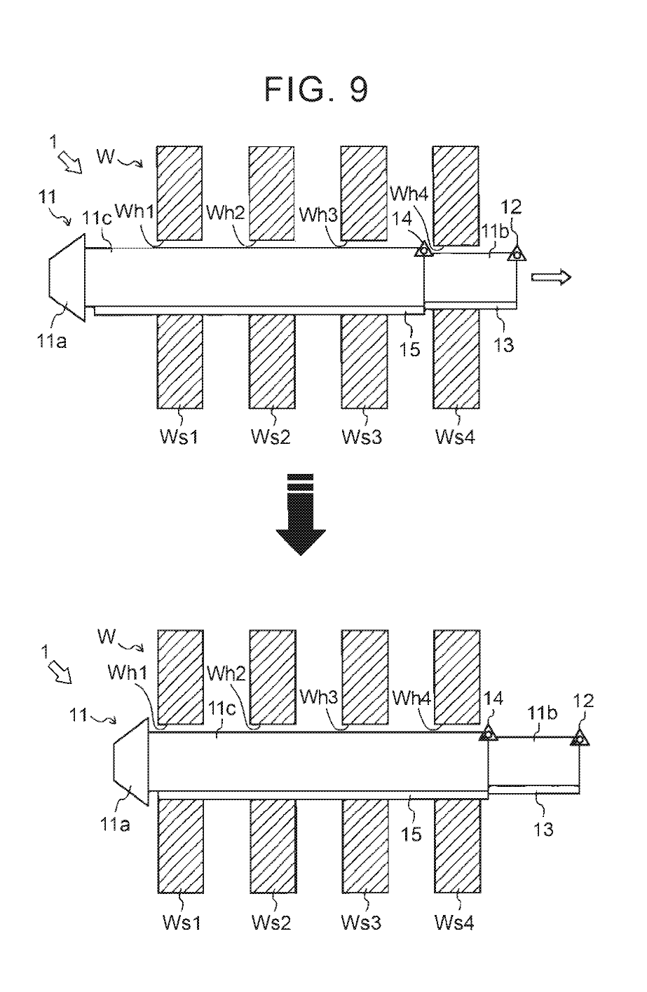

As illustrated in FIG. 9, in the fourth cutting step S50, the boring tool 1 driven by the machining tool is moved in the right direction until the second cutting blade 14 passes the through hole Wh4.

Thus, the inside diameter of the through hole Wh4 is adjusted to the same as the machining diameter of the second cutting blade 14.

In the fourth cutting step S50, at the time when the second cutting blade 14 cuts the through hole Wh4, the first guide 13 slides on the inner peripheral surface of the through hole Wh4 that has been cut by the first cutting blade 12, and the second guide 15 slides on the inner peripheral surface of the through hole Wh4 that has been cut by the second cutting blade 14, the inner peripheral surface of the through hole Wh3 that has been cut by the second cutting blade 14, the inner peripheral surface of the through hole Wh2 that has been cut by the second cutting blade 14, and the inner peripheral surface of the through hole Wh1 that has been cut by the second cutting blade 14.

As such, the shaft member 11 is supported by the first guide 13 and the second guide 15 on the right side and the left side of the second cutting blade 14. Further, the mounting portion 11a (see FIG. 1(a)) placed in the left end of the shaft member 11 is supported by the machine tool. That is, the shaft member 11 is supported at both ends.

This makes it possible to restrain the shaft member 11 from vibrating in the direction perpendicular to the axial direction in a part (the right end of the large diameter portion 11c) where the second cutting blade 14 is attached.

Accordingly, it is possible to cut the inner peripheral surface of the through hole Wh4 with accuracy without the inside diameter of the through hole Wh4 becoming larger than a target value.

As described above, in the boring step S1, the reference hole forming step S10, the first cutting step S20, the second cutting step S30, the third cutting step S40, and the fourth cutting step S50 are performed sequentially, so as to adjust the inside diameters of the through holes Wh1, Wh2, Wh3, Wh4 of the workpiece W.

Note that it is also possible to cut the through hole Wh1 by the first cutting blade 12 in the first cutting step S20 without performing the reference hole forming step S10.

Further, in the present embodiment, the axial dimension of the small diameter portion 11b of the shaft member 11 is set to be generally the same as the distance between one end surfaces, in the right-left direction, of adjacent support portions in the workpiece W, so that the step of the second cutting blade 14 cutting a through hole of the workpiece W and the step of the first cutting blade 12 cutting a through hole of the workpiece W are performed at the same time. However, the present invention is not limited to this configuration.

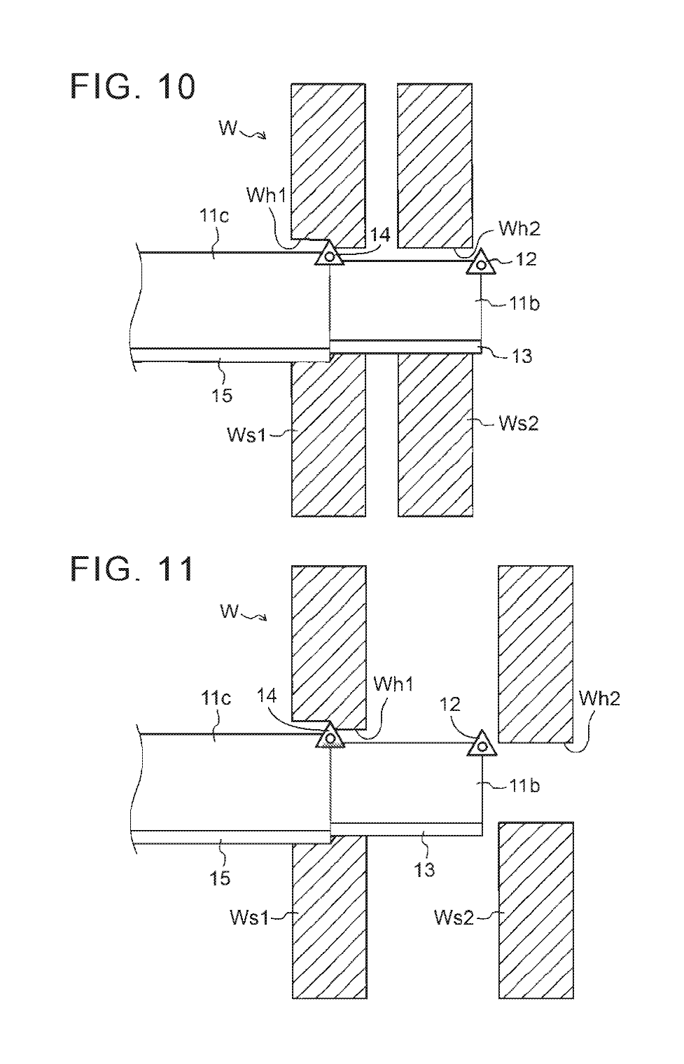

For example, as illustrated in FIG. 10, in a case where an interval between the support portion Ws1 and the support portion Ws2 in the workpiece W is relatively small, the step of the second cutting blade 14 cutting the through hole Wh1 and the step of the first cutting blade 12 cutting the through hole Wh2 are performed with a time lag.

In this case, at the time when the second cutting blade 14 cuts the through hole Wh1, the first guide 13 slides on the inner peripheral surface of the through hole Wh2 that has been cut by the first cutting blade 12 and the inner peripheral surface of the through hole Wh1 that has been cut by the first cutting blade 12, and the second guide 15 slides on the inner peripheral surface of the through hole Wh1 that has been cut by the second cutting blade 14.

Further, as illustrated in FIG. 11, in a case where the interval between the support portion Ws1 and the support portion Ws2 in the workpiece W is relatively long, the step of the second cutting blade 14 cutting the through hole Wh1 and the step of the first cutting blade 12 cutting the through hole Wh2 are performed with a time lag.

In this case, at the time when the second cutting blade 14 cuts the through hole Wh1, the first guide 13 slides on the inner peripheral surface of the through hole Wh1 that has been cut by the first cutting blade 12, and the second guide 15 slides on the inner peripheral surface of the through hole Wh1 that has been cut by the second cutting blade 14.

As such, regardless of an interval between adjacent support portions in the workpiece W, at the time when the second cutting blade 14 cuts the through hole of the workpiece W, the shaft member 11 is supported by the first guide 13 and the second guide 15 on the right side and the left side of the second cutting blade 14.

Accordingly, with the use of the boring tool 1, it is possible to flexibly perform boring on various workpieces W.

Note that in FIGS. 10 and 11, only the support portion Ws1 and the support portion Ws2 are illustrated for purposes of this description.

Further, in the present embodiment, the first guide 13 is formed continuously over a whole area of the small diameter portion 11b in the axial direction, and the second guide 15 is formed continuously over a generally whole area of the large diameter portion 11c in the axial direction. However, the present invention is not limited to this configuration.

The first guide 13 may be placed such that the first guide 13 slides on an inner peripheral surface of at least one through hole that has been cut by the first cutting blade 12, at the time when a through hole of the workpiece W is cut by the second cutting blade 14. Further, the second guide 15 may be placed such that the second guide 15 slides on an inner peripheral surface of at least one through hole that has been cut by the second cutting blade 14, at the time when the through hole of the workpiece W is cut by the second cutting blade 14.

Further, in the present embodiment, the small diameter portion 11b and the large diameter portion 11c are formed in the shaft member 11, but a part of the shaft member 11 except for the mounting portion 11a may have the same diameter.

In this case, positions of the first cutting blade 12 and the second cutting blade 14 may be adjusted so that the machining diameter of the first cutting blade 12 becomes smaller than the machining diameter of the second cutting blade 14. Further, a distance from a sliding surface of the first guide 13 to the shaft center of the shaft member 11 may be changed so that the guide diameter of the first guide 13 becomes the same as the machining diameter of the first cutting blade 12, and a distance from a sliding surface of the second guide 15 to the shaft center of the shaft member 11 may be changed so that the guide diameter of the second guide 15 becomes the same as the machining diameter of the second cutting blade 14.

Further, the first cutting blade 12 and the second cutting blade 14 may be configured so that their positions in the axial direction of the shaft member 11 are changeable.

Hereby, even in a case where the interval between adjacent support portions in the workpiece W is changed, it is possible to cut through holes formed in the adjacent support portions in the workpiece W at the same time by the first cutting blade 12 and the second cutting blade 14.

This accordingly causes the first guide 13 to slide on an inner peripheral surface of the through hole that has been cut by the first cutting blade 12, at the time when the second cutting blade 14 cuts the through hole, thereby making it possible to cut the through hole of the workpiece W with accuracy.

Further, in the present embodiment, the workpiece W having four through holes Wh1, Wh2, Wh3, Wh4 is employed as a machining object for the boring tool 1, but the workpiece W may be provided with at least two through holes.

### INDUSTRIAL APPLICABILITY

The present invention is usable in a boring tool for machining a plurality of through holes formed in a workpiece and for a boring method using the same.

### DESCRIPTION OF THE REFERENCE NUMERALS

1/Boring Tool
2/Reference Hole Forming Tool
11/Shaft Member
11a/Mounting Portion
11b/Small Diameter Portion
11c/Large Diameter Portion
12/First Cutting Blade
13/First Guide
14/Second Cutting Blade
15/Second Guide
21/Short Shaft Member
22/Cutting Blade
23/Guide
W/Workpiece
Ws1, Ws2, Ws3, Ws4/Support Portion
Wh1, Wh2, Wh2, Wh3, Wh4/Through Hole

1. A boring tool for performing boring on a workpiece that has a plurality of through holes formed coaxially and distanced from each other, in such a manner that the boring tool is inserted into the plurality of through holes sequentially, the boring tool comprising:
a shaft member attached to a machine tool at a first end of the shaft member and rotationally driven by the machine tool around a shaft center of the shaft member;
a first cutting blade fixed to the shaft member to project from an outer peripheral surface of the shaft member and configured to cut an inner peripheral surface of a first through hole so that the first through hole has a first inside diameter, the first through hole being one of the plurality of through holes;
a first guide fixed to the shaft member to project from the outer peripheral surface and configured to slide on the inner peripheral surface of the first through hole;
a second cutting blade fixed to the shaft member to project from the outer peripheral surface and configured to cut the inner peripheral surface of the first through hole so that the first through hole has a second inside diameter, the second cutting blade being placed at a predetermined interval from the first cutting blade and being closer to the first end than the first cutting blade; and
a second guide fixed to the shaft member to project from the outer peripheral surface and configured to slide on the inner peripheral surface of the first through hole, wherein
the first guide is placed so as to slide on an inner peripheral surface of at least one of the plurality of through holes that has been cut by the first cutting blade, when the inner peripheral surface of the first through hole is cut by the second cutting blade, and
the second guide is placed closer to the first end than the first guide so as to slide on an inner peripheral surface of at least one of the plurality of through holes that has been cut by the second cutting blade, when the inner peripheral surface of the first through hole is cut by the second cutting blade.

2. The boring tool according to claim 1, wherein
the shaft member includes
a small diameter portion having a predetermined outside diameter and formed in an axial direction from a second end of the shaft member to a halfway of the shaft member, and
a large diameter portion having an outside diameter larger than the predetermined outside diameter and formed coaxially and integrally with the small diameter portion, the large diameter portion being closer to the first end than the small diameter portion;
the first cutting blade and the first guide are fixed to the small diameter portion; and
the second cutting blade and the second guide are fixed to the large diameter portion.

3. The boring tool according to claim 1, wherein
the first cutting blade is placed such that the first cutting blade cuts an inner peripheral surface of a through hole adjacent to the first through hole, when the inner peripheral surface of the first through hole is cut by the second cutting blade.

4. A boring method of performing boring on the plurality of through holes of the workpiece by use of the boring tool according to claim 1, the boring method comprising:
preparing a reference hole forming tool, the reference hole forming tool including
a short shaft member rotationally driven around a shaft center of the short shaft member by the machine tool, and having an axial dimension smaller than the shaft member, an end of the short shaft member being attached to the machine tool,
a cutting blade fixed to the short shaft member to project from an outer peripheral surface of the short shaft member and configured to cut an inner peripheral surface of a second through hole so that the second through hole has an inside diameter that is equal to or larger than a machining diameter of the first cutting blade and smaller than a machining diameter of the second cutting blade, the second through hole being placed on an end among the plurality of through holes, and
a guide configured to slide on the inner peripheral surface of the second through hole;
cutting, by the cutting blade, the inner peripheral surface of the second through hole, so that the second through hole serves as a reference hole;
inserting the shaft member into the reference hole and cutting an inner peripheral surface of the reference hole by the second cutting blade; and
cutting an inner peripheral surface of a through hole adjacent to the reference hole by the first cutting blade.
